(19) United States
(12) Patent Application Publication
(10) Pub. No.: US 2007/0174219 A1
(43) Pub. Date: Jul. 26, 2007

(54) Renewable energy usage fee

(76) Inventors: Christian Bryant JR., Keizer, OR (US); Clyde Dewain Feyrer, Molalla, OR (US); Melvin Reshaud Young, Salem, OR (US)

Correspondence Address: Christian James Bryant, Jr., 605 Village Drive, Molalla, OR, 97038, US

(21) Appl. No.: 11/337,017

(22) Filed: Jan. 23, 2006

(51) Int. Cl. G06F 17/00

(52) U.S. Cl. 705/412

(57) ABSTRACT

A method of collecting, analyzing, calculating and comparing the production of electricity by a renewable energy device; said renewable energy device is capable of having the amount the production of electricity communicated with a said online gathering system; and an independent device, or another renewable energy device or historical meteorological database for verifying of said production of electricity from said renewable energy device in order to calculate the said usage fee

### BACKGROUND OF INVENTION

(i) Field of Invention

The present patent application relates to a novel method of collecting, analyzing, calculating, and comparing the production of electricity by a renewable energy device; said renewable energy device is capable of having the amount the production of electricity communicated with a said online gathering system; and an independent device, or another renewable energy device or historical meteorological database for verifying of said production of electricity from said renewable energy device in order to calculate the said usage fee.

### HISTORY OF INVENTION

One of the major disadvantages of the renewable energy device that produces alternative electricity for consumption is the high capital cost of this device. The second limitation is the necessity to build large scale systems in order to reduce the capital cost and this requirement necessitates their location to available transmission lines to support such large-scale systems. Finally, the price of the electricity often limits the type of renewable energy devices that can be used because of the practicality of the cost. In order to address those limitations of incorporating renewable energy devices, our invention makes it possible for every one to have a renewable energy device producing electricity provided there is sufficient meteorological data to support such a device. In our invention, the landholder or user of our renewable energy device would not have to buy the equipment or pay the high capital costs. Instead we charge the landholder or rate holder a usage fee in which he pays to our company using our invention. Instead of locating these devices into large collections of systems, we want to distribute them around the grid so that the local production of electricity can be used by many homes. Our invention allows for one to collect, analyze, and compare the production of electricity by a renewable energy device; said renewable energy device is capable of having the output of electricity with a said online gathering system and an independent device, other renewable energy devices or historical meteorological databases for verifying of said production of electricity from said renewable energy device in order to calculate the said usage fee. It allows for a better method of incorporating the renewable energy devices into our electrical grid and simplifies the process of introducing the renewable energy devices. It overcomes the basic limitation of capital costs by not having to require the sell of electricity at wholesale prices; instead the electricity price is based upon a usage fee arrangement. Finally our invention allows the wholesale adoption of renewable energy by the mass market thus reducing the capital costs.

(ii) Description of Related Art

In US Patent application 20010176962 Winch and others patented an apparatus and method of monitoring, comparing, calculating storing, transmitting and billing durable goods operating usage fee for equipment based upon the type, amount, and location of usages; amount of usage, and location of usage of the equipment. Based on the type of usage, discount or penalty can be added to the equipment usage fee based upon predetermined depreciation levels. Also, an equipment availability fee can be added to the equipment. In this case, there is an apparatus, namely the monitoring equipment that monitors the equipment in order to calculate the usage fee. In our invention, the renewable energy device is independent of the monitoring equipment, namely the independent device that measures the meteorological data that produces the electricity. Although, Winch's patent application outlines the major advantage in the usage fee approach, the disadvantage of this invention is that it requires another apparatus to monitor the equipment that is attached to the device. Such an apparatus might obtain incorrect meteorological data due to interference from the renewable energy device while it is producing energy. The better approach for a renewable energy device using our invention is having the independent device be independent of the device itself and measuring the meteorological data used in producing electricity.

In patent application 20020032277, the inventors Yamamoto et al describe a computer system assisting collection of gadgets. Here the inventors are faced with numerous gadgets like stoves and other household items that need to be recycled. The invention has a computer system that calculates the usage fee based upon the prior use of the gadget in exchange for them collecting the gadget for recycling. The usage fee is a method of calculating the residual value of the item in question. In our invention the usage fee is based upon the actual electricity produced by the renewable energy device.

Another patent by Young, U.S. Pat. No. 6,721,223, describes a usage fee method for underground utilities, cable, and telephone lines. Here in this invention, the idea is to provide some online mapping system of underground utilities, cables, and telephone lines, so that repairmen and real estate developers can avoid damaging these underground utilities. The mapping data is provided under a usage fee arrangement wherein the high cost of building, collecting and changing the underground utilities are managed by independent companies which frays the cost of this by charging a usage fee.

### DESCRIPTION OF DRAWINGS

FIG. 1 a diagram of a renewable energy device with an independent means to measure the meteorological data.

FIG. 2. A diagram of a renewable energy device with a historical meteorological database connected to gathering systems.

FIG. 3. A diagram of a renewable energy device with other renewable energy devices to provide a cross correlation of the meteorological data.

### SUMMARY OF THE INVENTION

The application has thus sought a method of collecting, analyzing, calculating and comparing the production of electricity by a renewable energy device; said renewable energy device is capable of having the output of the production of electricity with a said online gathering system, an independent device, other renewable energy devices, or a historical meteorological database for verifying or calculating of said production of electricity from said renewable energy device in order to calculate the said usage fee.

### DETAIL DESCRIPTION OF INVENTION

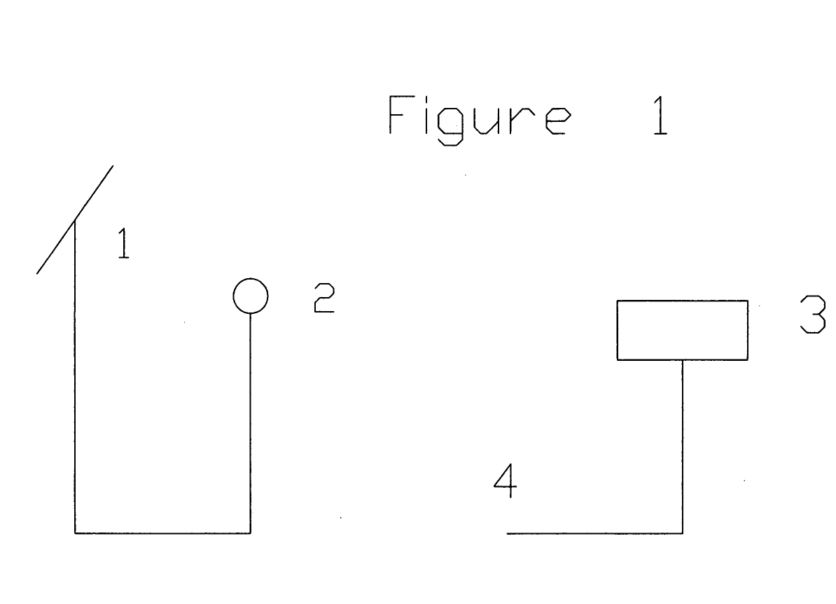

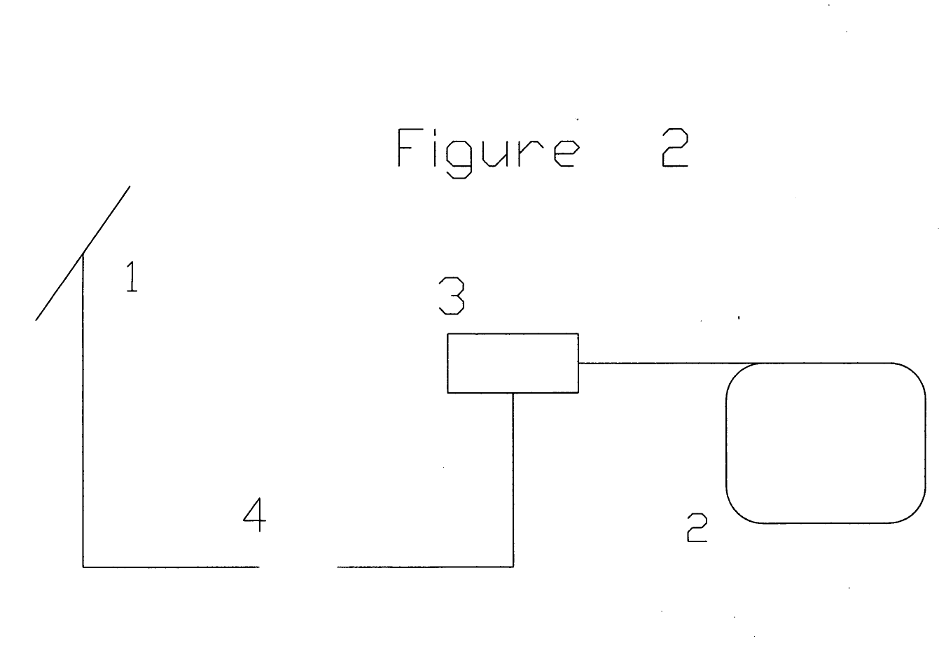

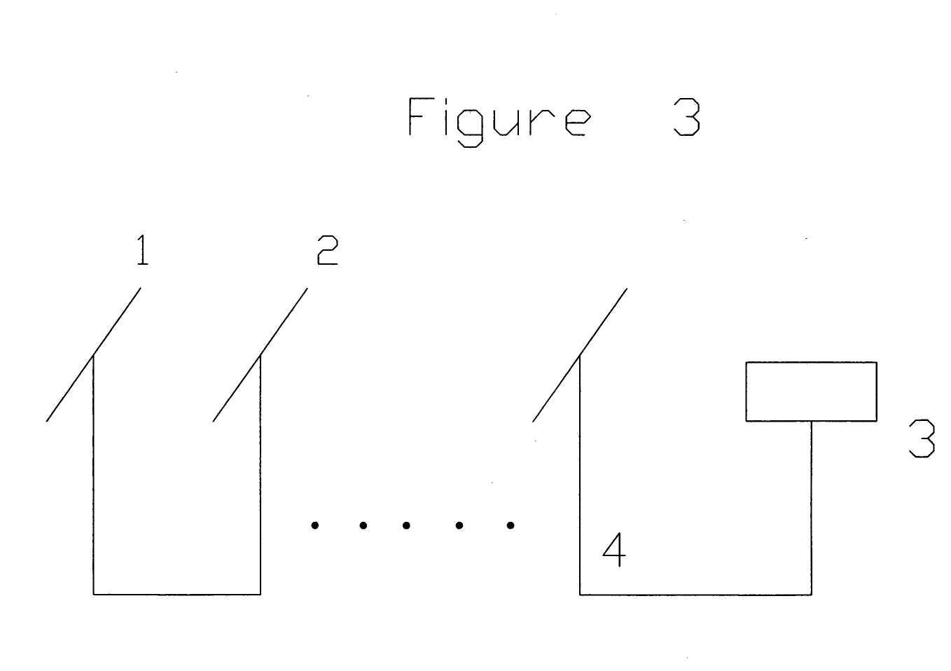

The preferred embodiment is FIG. 1 wherein there is an independent device capable of measuring the meteorological data used by renewable energy device to produce electricity. This independent device measures the meteorological data allowing one to verify the output of the electricity production from any renewable energy device. These independent devices are generally a system that measures the meteorological data of wind speed or sunlight. FIGS. 2 and 3 are another method on constructing our invention where they either rely on a historical meteorological database or other renewable energy devices located in the same region or area. In the later method, a cross correlation of the data from each renewable energy device is used to verify the production information in determining the usage fee.

In FIG. 1 that renewable energy device, like a solar device or wind turbine (1), is connected to a power grid producing electricity such as a renewable energy device that could be a high concentration solar array like those produced by Amonix or Solar Systems, Ltd, Pty. They also include roof-top systems and concentrated solar thermo device like those incorporated by Southern California Edison. Or, a small wind turbine produced by a number of manufacturers. The output of the amount of electricity is connected to telecommunication lines that are interfaced with (1) the Internet or cellular telecommunication systems wherein the amount of production of electricity is communicated to the online gathering systems comprising of internet (1) or cellular (1) phone system and remote computer systems (3). The online gathering system (3) processes the information received from renewable energy devices (1) that is sent down to communication systems (1) and to the online gathering system (3). If the renewable energy device is a solar device, the independent device that can verif the production of electricity is Pyrometer or pyrohelixmeter (2) that measures the amount of solar irradiation. This independent device (2) is also communicating contemporaneously information to the online gather systems (3). If the renewable energy device (1) is a wind turbine, the independent device (2) is an anemometer that measures the wind speeds. This independent device (2) is communicating contemporaneously information to the online gather systems (3). The information produced by independent devices (2) received by the online gather systems (3) allows one to calculate together with the information sent by renewable energy device (1) the correct usage fee. In the case of a solar array, the pyrometer (2) allows one to calibrate the solar array (1) to determine if the solar array is producing the correct amount of electricity by the online gather system (3). If the production from the solar array (1) of electricity is low, it could mean that the solar array (1) has a number of possible problems including dirty lenses, the solar array is registering incorrectly toward the sun, or that something else is not working correctly. If the case where the renewable energy device (1) is a wind turbine, the independent device (2) to verify of electricity by wind turbine can alert the operator to possible problems with the wind turbine including dirty wind vanes, or wore out breaks in the wind turbines. By having a independent device (2) communicating information (1) to online gathering systems (3), the operator of the small renewable energy farm can determine what repairs, if any need to be made, but more importantly, it can adjust the usage fee that the landowner pays for the renewable energy device (1). The major difference between a leasing fee and usage fee are that the landowner will never own the renewable energy device, the operator owns the device and second, the usage fee will be to cover the cost of the monthly lease cost of renewable energy devices including maintenance and marketing expenses, plus a profit.

Another embodiment of this invention is when the historical meteorological database as an independent way of verifying that production of electricity from said renewable energy device in order to calculate the said usage fee. This meteorological database is used instead of independent devices to verify the production. In FIG. 2 that renewable energy device like a solar device or wind turbine (1) is connected to a power grid producing electricity. The output of the amount of electricity is connected to telecommunication lines that is interfaced with (1) the Internet or cellular telecommunication systems wherein the amount of production of electricity is communicated to the online gathering systems comprising of internet (1) or cellular (1) phone systems and remote computer systems (3). The online gather systems (3) process the information received from renewable energy device (1) that is sent down from the communication systems (1) to the online gather system (3). If the renewable energy device is a solar device, the historical meteorological database (3) comprises solar irradiation data produced by satellites like the SODA database developed by the French as an independent way of verifying that production of electricity from said renewable energy devices in order to calculate the said usage fee. If the renewable energy device (1) is a wind turbine, the historical meteorological database (2) can be from the previous measuring of the site or the databases that can be obtained from universities or private sources. This is an independent way of verifying the production of electricity from said renewable energy device (1) in order to calculate the said usage fee. The online historical meteorological database is apart of the online gathering systems (3). The information produced by the renewable energy device (1) is received by the online gathering system (3) with a historical meteorological database (2) allows one to calculate together with the information sent by renewable energy devices (1) the correct usage fee. Again, if the production from the solar array (1) of electricity is low, it could mean that the solar array (1) has a number of possible problems including dirty lenses, the solar array is registered incorrectly toward the sun, or that something else is not working correctly. If the case where the renewable energy device (1) is a wind turbine, the meteorological database will verify the production of electricity by the wind turbine and can alert the operator to possible problems with the wind turbine. By having a historical meteorological database (2) with the online gathering systems (3), the operator of the small renewable energy farm can determine what repairs, if any, need to be made, but more importantly, it can adjust the usage fee that the landowner pays for the renewable energy device (1)

Another embodiment of this invention is when the other renewable energy devices are located and there electricity production data is communicated to the online gathering systems as an independent way of veriying that production of electricity from said renewable energy device in order to calculate the said usage fee. In this method, other renewable energy devices are used as the independent method to verify the production. In FIG. 6 that renewable energy device like a solar device or wind turbine (1) is connected to a power grid producing electricity. The output of the amount of electricity is connected to telecommunication lines that are interfaced with (1) the Internet or cellular telecommunication systems wherein the amount of production of electricity is communicated to the online gathering systems comprising of internet (1) or cellular (1) phone systems and remote computer systems (3). The online gathering system (3) processes the information received from renewable energy device (1) that is sent down through the communication system (1) to the online gather system (3). In this embodiment, the other renewable energy devices electricity production is also contemporaneously communicated to the online gathering systems. By having these renewable energy devices be they solar arrays or wind turbines located in the same area, would give the operator a method of cross correlating the date with the particular renewable energy device (1) that is communicating its production information. This is an independent way of verifying that production of electricity from said renewable energy device (1) in order to calculate the said usage fee.

We claim:

1. A method of collecting, analyzing, calculating and comparing the production of electricity by a renewable energy device; said renewable energy device is capable of having the output of the production of electricity with a said online gathering system and an independent device for verifying of said production of electricity from said renewable energy device in order to calculate the said usage fee.

2. A method in claim 1, wherein the said renewable energy device is a high concentration solar array or roof-top solar systems.

3. A method in claim 1, wherein the said renewable energy device is a highly concentrated solar thermo machine.

4. A method in claim 1, wherein the said renewable energy device is a wind turbine

5. A method in claim 1, wherein the independent way of verifying the production information is a pyrometer for solar energy.

6. A method in claim 1, wherein the independent way of verifying the production information is a pyrohelexometer for solar energy

7. A method in claim 1, wherein the independent way of verifying the production information is an anemometer for wind density.

8. A method in claim 1, wherein the said online gathering system is the Internet communication system.

9. A method in claim 1, wherein the said online gathering system is a cellular communication system.

10. A method of collecting, analyzing, calculating, and comparing the production of electricity by a renewable energy device; said renewable energy device is capable of having the output of the production of electricity be compared to historical meteorological database as an independent way of verifying that production of electricity from said renewable energy devices in order to calculate the said usage fee.

11. A method in claim 2, wherein the said renewable energy device is a high concentration solar array or roof-top solar systems.

12. A method in claim 2, wherein the said renewable energy device is a highly concentrated solar thermo machine.

13. A method in claim 2, wherein the said renewable energy device is a wind turbine

14. A method in claim 2, wherein the said historical database system is a meteorological database comprising of the historical solar data.

15. A method in claim 2, wherein the said historical database is the metrological database of wind density.

16. A method of collecting, analyzing, calculating, and comparing the production of electricity by a renewable energy device; said renewable energy device is capable of having the output of the production of electricity to be compared by cross correlation of other renewable energy devices near the installation said renewable energy device is an independent way of verifying that production of electricity from said renewable energy devices in order to calculate the said usage fee.

17. A method in claim 3, wherein the said renewable energy device is a high concentration solar array or roof-top solar system.

18. A method in claim 3, wherein the said renewable energy device is a highly concentrated solar thermo machine.

19. A method in claim 3, wherein the said renewable energy device is a wind turbine

20. A method in claim 3, wherein the cross-correlation of other solar arrays near the installation is a method of verifying the production information and the output of electricity for said solar energy.

21. A method in claim 3, wherein the cross-correlation of other wind turbines near the installation is a method of verifying the production information and the output of electricity for said wind energy.
